(19) United States
(12) Patent Application Publication
(10) Pub. No.: US 2017/0184506 A1
(43) Pub. Date: Jun. 29, 2017

(54) REAGENT TEST STRIPS COMPRISING REFERENCE REGIONS FOR MEASUREMENT WITH COLORIMETRIC TEST PLATFORM

(71) Applicant: Pritesh Arjunbhai Patel, Novato, CA (US)

(72) Inventor: Pritesh Arjunbhai Patel, Novato, CA (US)

(21) Appl. No.: 15/170,778

(22) Filed: Jun. 1, 2016

Related U.S. Application Data
(60) Provisional application No. 62/272,097, filed on Dec. 29, 2015.

(51) Int. Cl. G01N 21/78

(52) U.S. Cl. CPC G01N 21/78; G01N 2021/7759

(57) ABSTRACT

Disclosed is a reagent strip comprising test region(s) and reference region(s). The reference region(s) display a predetermined response to a range of possible concentrations of an analyte applied to the corresponding test region(s). Furthermore, the reference region(s) and the test region(s) are arranged on the reagent strip so as to facilitate analysis of a qualitative state of the analyte and optionally, calculation of a quantitative value of the analyte at point-of-collection. Also disclosed is a method of manufacturing such reagent strips, first involving printing the reference region(s) and the test region(s) in a continuous and alternating series on a test strip precursor substrate. The method also involves cutting the test strip precursor substrate perpendicularly to the printed columns to obtain one or more reagent strips. Also disclosed is a method encompassed in a mobile application for determining a qualitative state and optionally calculating a quantitative state of the analyte.

### CLAIM OF PRIORITY

This application claims priority to U.S. Provisional Patent Application Ser. No. 62/272,097, filed Dec. 29, 2015, the entire disclosure of which is hereby expressly incorporated by reference herein.

### FIELD OF TECHNOLOGY

The present invention relates generally to reagent strips and more particularly to a method of manufacturing a reagent test strip with one or more reference regions for optimally obtaining a qualitative state of an analyte, and optionally determining a quantitative value of the analyte through a data processing device.

### BACKGROUND

Conventional, portable colorimetric diagnostics tools such as paper strips, microfluidic paper assays, and reagent strip-based systems that use color change to measure the value of the analyte have been available in the market for many years. Such colorimetric strips are commonly used for analysis of urine, blood, water, pH, industrial pollutants, or chemicals and have the tremendous potential of providing simple, low-cost, rapid point-of-collection (POC) systems.

An exemplary colorimetric reaction test platform may comprise the measurement of an analyte such as Vitamin D, glucose, cholesterol, in a sample such as blood saliva, sweat or urine. Urine analysis reagent strips are commonly available, such as Cybow™, Mission™, Rapid Diagnostics and other such commercially available strips. Urine analysis strips can measure 10 or 11 of such analytes such as ketones, glucose etc. Similarly, blood glucose and cholesterol measurements are possible using reagent test strips. Similarly, pool and spa water can be analyzed using reagent test strips. The colorimetric test platforms are also embedded to measure analyte in non-biological systems such as pool water chemistry for analytes such chlorine, cynauric acid, hardness, pH, bromine, etc. Industrial waste water or other chemicals (such as heavy metals, chlorine, etc.) may also be measured by colorimetric reaction test platforms embedded in the reagent test strips.

Commercial colorimetric test strips are usually analyzed by the naked eye by comparing the color obtained during the measurements with a reference chart provided with the test strips. Examples of such colorimetric paper assays include standard pH (Litmus) paper, urine and blood glucose analysis strips, pool and spa water chemical analysis strips, industrial and environmental chemical analysis strips and many others. The colorimetric results of these assays are viewed by the naked eye, which presents challenges in precisely quantifying the analyte amount or interpreting the results.

In producing such reagent test strips, one or more strips of reagent are typically applied to a substrate and dried. The test strip deposition of reagent often includes a continuous web of material proceeding from a reagent coating station to a reagent drying stations, and finally to a rolling station. Coated substrate is often then associated with other elements and singulated to produce individual test strips. Dry phase reagent strips incorporating chemical and enzyme-based compositions or other reagents are used extensively in hospitals, clinical laboratories, physician's offices, and homes to test samples of biological fluids.

The majority of existing commercial colorimetric reagent strip-based products do not provide any associated smart phone systems that determine value(s) of the color(s) of the reagent test strip during the test. Currently, a user of such systems must evaluate the analyte sample by his/her naked eye and manually interpret the results. There are no provisions to record such results and track the results against time.

Mobile phones have the ability to offer test strip imaging directly on a phone and the processed data can be stored for tracking or sent via email directly to an interested party e.g., physician for the medical diagnostics, pool care technician for a pool chemistry analysis, or industrial agent for an environmental chemical detection. In recent years, the potential applications of aforementioned POC systems have been further enabled by proliferation of the “smart phones” that typically have internet connectivity, high resolution cameras and touch-screen user displays along with powerful processors, enabling colorimetric analysis of the reagent strip at the POC rather than relying on the user and an accompanying reference chart.

Though there exist smartphone applications that utilize smartphone capabilities (e.g. camera, processing, remote communication), current smartphone applications struggle to obtain accurate, consistent, and standardized measurements. This task is exponentially more difficult when factoring in varying environmental conditions (e.g. intensity and color of light) and the varying specifications of smartphones and their associated camera devices.

Additional requirements of such systems are to provide an easy to use platform with minimal training for measurement of the analyte using the colorimetric test strips. Users evaluate samples by naked eye comparing of the analyte test sample after the colorimetric reaction and manually interpret the results. There are no provisions available to record such results and track the results against time.

Indeed, some investigators have demonstrated the use of mobile phones for on-site medical diagnostics for point-of-collection systems such as biomarkers in blood (glucose, lipids), urine, sweat, and saliva (Yetisen, 2013). However, use of colorimetric image analysis of such diagnostic assays using an image taken from mobile phone camera still has many limitations, such as (a) impact of the varying lighting conditions during image acquisition, (b) image manipulation at pixel level due to integrated automatic color balancing of various cell phone operating systems prevents accurate color quantitative measurements and further requires image correction, (c) large amount of the processing power is required to perform image analysis, and (d) small changes in color are indistinguishable by typical color measurement systems. Hence, there is need to obtain accurate, consistent, and standardized quantitative measurements independent of the system used for measurements, and of the conditions that influence the colorimetric image analysis.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY OF THE INVENTION

In one aspect, a reagent strip for determining a qualitative state or quantitative value of an applied analyte is disclosed. The reagent test strip comprises a strip precursor substrate. The reagent also comprises a continuous array of analysis regions disposed on the strip precursor substrate. Each of the analysis regions are configured as either a test region provided to receive the applied analyte or as a reference region provided to display a specified pattern. The specified pattern represents a range of predetermined responses of the corresponding selected test regions to a range of concentrations of the applied analyte. Each reference region of the reagent test strip is disposed adjacent to one of the test region so as to enable acquisition of an image consisting of both a selected test region having the applied analyte and a selected reference region. The qualitative state of the applied analyte can be determined at a point-of-collection. The determination of the qualitative state of the applied analyte on the selected test region is based on a calibration performed from the specified pattern on the corresponding selected reference region.

In another aspect, a method of manufacturing reagent test strips for determining qualitative states or quantitative values of applied analytes is disclosed. The method comprises a step of printing a plurality of reference region columns and applying a plurality of test region columns in a continuous and alternating series on a test strip precursor substrate. Each reference region column is disposed adjacent to at least one of the test region columns and each test region column is disposed adjacent at least one of the reference region columns. The method also comprises a step of cutting the test strip precursor substrate perpendicularly to the printed columns to produce a plurality of the reagent test strips. Each reagent test strip has disposed thereon a linear array of reference regions and test regions.

In yet another aspect, a method of measuring a concentration of an applied analyte at a point-of-collection using a reagent test strip is disclosed. The method comprises a step of detecting, through a data processing device, a continuous array of analysis regions disposed on the reagent test strip. Each of the analysis regions is configured as either a test region provided to receive the applied analyte or as a reference region provided to display a specified pattern. Each reference region is disposed adjacent at least one test region so as to enable acquisition of an image consisting of both a selected test region having the applied analyte and a selected reference region. The method also comprises a step of determining a qualitative state of the applied analyte at the point-of-collection. The method further comprises an optional step of calculating a quantitative value of the analyte at the point-of-collection based on a calibration performed at the point-of-collection from the specified pattern of the selected reference region.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates the reagent test strip containing colorimetric test regions and the reference color regions that are adjacent to the test regions, in accordance with at least one embodiment;

FIG. 2 illustrates various color patterns that may be used in the reference color region of the reagent test strip, in accordance with at least one embodiment;

FIG. 3 illustrates a manufacturing process for manufacturing reagent test strips containing one or more reference regions having a horizontally-oriented pattern and one or more colorimetric test regions on a test strip precursor substrate to obtain reagent test strips, in accordance with at least one embodiment;

FIG. 4 illustrates a manufacturing process for manufacturing reagent test strips containing one or more reference regions having a vertically-oriented pattern and one or more colorimetric test regions on a test strip precursor substrate to obtain reagent test strips, in accordance with at least one embodiment.

FIG. 5 illustrates a flowchart of a method to manufacture a reagent test strips containing a colorimetric reagent test region and a reference color region, in accordance with at least one embodiment;

FIG. 6 illustrates a flowchart of a method to analyze reagent test strips for obtaining a qualitative state of an analyte, and optionally determining a quantitative value of an analyte in a sample using the reagent test strips through a mobile device, in accordance with at least one embodiment;

Other features of the present embodiments will be apparent from the accompanying drawings and from the detailed description that follows.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent applications mentioned herein are incorporated herein in their entirety.

It is also noted that as used herein and in the appended claims, the singular forms “a”, “and”, and “the” include plural referents unless the context clearly dictates otherwise. In the claims, the terms “first,” “second”, and so forth are to be interpreted merely as ordinal designations they shall not be limited in themselves. Further, the use of exclusive terminology such as “solely,” “only” and the like in connection with the recitation of any claim element is contemplated. Also, it is contemplated that any element indicated to be optional herein may be specifically excluded from a given claim by way of a “negative” limitation. Finally, it is contemplated that any optional feature of the inventive variation(s) described herein may be set forth and claimed independently or in combination with any one or more of the features described herein.

Definitions: The following terms shall have, for the purposes of this application, the respective meanings set forth below.

The term ‘colorimetric test region’ or ‘test platform’ or ‘colorimetric test platform’ or ‘test region’ as may be used herein and in the claims means a medium capable of receiving a target sample or samples and having the appropriate reagents comprising of chemistries, multiple chemistries, particles, or treated surface, where on application of a sample produces at least a measurable color change from one color to a different color or a measurable change in intensity of a particular color, or change in the uniformity of the medium, occurs in the presence of the analyte.

The term ‘reagent strip’ or ‘reagent test strip’ or ‘test strip’ or ‘colorimetric test strip’ or ‘paper strip’ as may be used herein and in the claims may refer to a device, system, or a strip that comprises of a colorimetric test platform. Such reagent test strips may and usually do include multiple test regions where more than one analytes are measured with a single test. Practical examples of embodied test platforms include, but are not limited to, various commercially available test strips as referenced in this disclosure.

The term ‘analyte’ may refer to of the specific chemical, or biomarker, or marker or the physical property such as specific gravity or similar that is intended to be measured in a given sample using the reagent test strip.

The term ‘measurement value’, ‘analyte value’, ‘quantitative value’, or ‘qualitative state’ may refer to the typical sample measurement results that are obtained from the reagent test strip. The qualitative state refers to the state of the analyte in a sample such as low/medium/high, or positive/negative or detecting the presence of the analyte or similar. The term quantitative value refers to the numeric value of the analyte concentration measured using the reagent test strip.

The term ‘colorimetric reaction’ may refer to the reaction of the analyte when in contact with the colorimetric test platform.

The term ‘color chart’ or ‘color pattern’ refers to colors adjacent to each other or in a gradient. Each of the colors in a color pattern may correspond to a color in a specified color system used to calibrate or correct an acquired image at a point-of-collection to remove variation in the ambient conditions. It may also correspond to the expected color response for a value of the analyte in a given range in a sample when the colorimetric reaction has taken place.

The term ‘pattern recognition’ refers to the detection of a specified pattern and the associated information embedded within the pattern in an image taken from the smartphone camera during the image analysis by the app or application.

As used herein, the term ‘data processing device’, ‘mobile device’, ‘mobile phone’, ‘smartphone’, ‘mobile test’ means an apparatus such as personal digital assistant that is capable of taking an image of the test system and running a programmed application suitable for executing the embodied functionality. While suitable traditional phones may include products such as, e.g., iPhone®, iPad®, Galaxy S®, Nexus, and other well-known devices and associated operating systems such as Android, iOS, and Windows Phone, the term mobile phone as discussed and embodied herein is intended to include any digital mobile device such as smartphones, tablets, phablets, smart watches, and other current or future ‘smart’ platforms having a similar functionality.

The term ‘point-of-collection’ as may be used herein and in the claims means making a rapid target measurement at the time a sample is collected on reagent test strip in possession of the user and then used in the analysis using the proposed method or system embodied in the invention. The term ‘point-of-collection conditions’ refers to the multitude of the conditions encountered while using the embodied method or system in the invention such as varying lighting conditions (daylight, artificial light such as camera flash, or night lights) and other physical conditions that are typically refers as ambient conditions.

The term ‘application’ or the ‘app’ refers to a program with specified instructions capable of being executed by the mobile device's processor.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and plural, unless indicated herein or clearly contradicted by context. The terms “comprising”, “having”, “including”, and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value failing within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

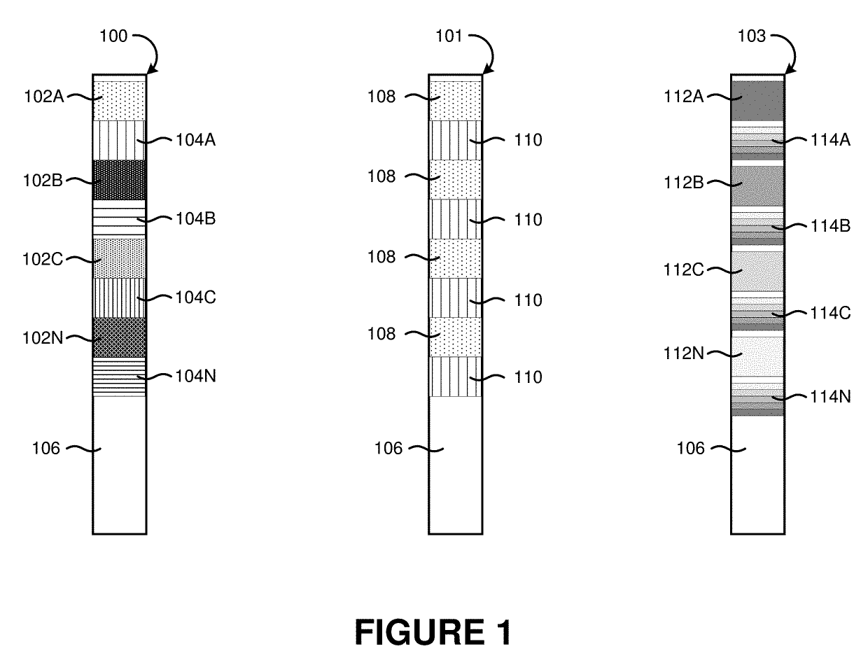

FIG. 1 illustrates reagent test strips 100, 101, and 103 manufactured containing a colorimetric test region where the reagent materials are deposited and reference color regions that are adjacent to the test regions, in accordance with at least one embodiment. Features of particular interest include: (1) a test region (e.g. test regions 102A-N, test region 108, test regions 112A-N) that contains a reagent material embedded in a strip of webbing material, and (2) a reference region (e.g. reference regions 104A-N, reference region 110, reference regions 114A-N). The reagent material may be applied in solution to form to a filter pad or web of the material and dried to produce the strip of the test region. Such reagent material typically contains a reagent that is sensitive to at least one of a chemical colorimetric reaction, an enzymatic colorimetric reaction, a nanoparticle colorimetric reaction, a reaction that changes the appearance of the sample (e.g., producing spots in otherwise uniform material), and a polymerase reaction.

In one embodiment, the reagent test strip 100 may comprise different test regions 102A-N and different reference regions 104A-N. Reference regions may constitute multiple stripes of varying color, a color gradient, or similar shapes comprising of multiple colors such as a rectangle, a square or similar patterns arranged in any order. Such shapes of color or color gradient may be in any direction with respective to the reagent strip 100. In one embodiment, reference region 104A of strip 100 shows such rectangular stripes in a vertical direction with respect to the test sample region; in another embodiment, reference region 104B of reagent strip 100 shows rectangular strip stacked horizontally; in another embodiment, reference region 104C of reagent strip 100 shows thin rectangles in a vertically direction; and in yet another embodiment, reference region 104N of reagent strip 100 shows thin rectangles stacked horizontally. Some or all of the reference regions 104A-N or 114A-N may have a nominal space in between the rectangles stacked horizontally or vertically. Some or all of the reference regions 104A-N or 114A-N may comprise a gradient or other color pattern. Furthermore, some or all of the reference regions 104A-N or 114A-N may follow the same pattern. In one embodiment, a strip 101 may comprise test regions 108 made from the same reagents and reference regions 110 exhibiting the same color pattern. In one embodiment, the range of colors of the reference region 114A may be suitable for use by an image analysis algorithm designed to correct the effect of the ambient conditions at point-of-collection to generate a calibration that may be utilized to optimally determine a quantitative value or a qualitative state of the analyte tested by the test region.

One embodiment of the invention comprises a reference region 104A-N or 114A-N of the reagent strip in which a color of the reference region is “inert” or does not change when exposed to the sample. The inertness of the reference region to the sample allows appropriate calibration using the reference colors from the image taken from the mobile device. Further, reference regions having printed colors may be hydrophobic in cases where the sample is hydrophilic, and vice-versa to avoid interference in the reflectance of the color.

In one embodiment, the reference regions 104A-N or 114A-N comprise a range of color corresponding to the range of the state or value of the analyte concentration expected while analyzing the sample. Alternately, the reference regions 104A-N or 114A-N may comprise a stippled pattern. Such reference regions in reagent test strips may allow the user, or the image analysis application using the image of reagent test strip for analysis, to directly compare the color produced in the test region by the sample to the reference regions to determine the state of the analyte conditions or concentration in the sample by comparison. In such case, the reference regions 104A-N or 114A-N are unique to each of the test regions and are located adjacent to the test regions, typically above or below, as illustrated in FIG. 1, in the reagent test strips.

In another embodiment, reagent test strip 103 may comprise test regions 112A-N and reference regions 114A-N. The test regions 112A-N may comprise a number of different reagent materials. Corresponding with each of the test regions 112A-N may be a reference region 114A-N having a series of horizontally-arranged colored stripes forming a gradient. Depending on the type of analyte tested by the test region 112A, the corresponding reference region 114A may comprise a range of colors that the test region 112A may display when exposed to an analyte. The range of colors of the reference region 114A may be suitable for use by an image analysis algorithm designed to generate a calibration curve that may be utilized to optimally determine a quantitative value or a qualitative state of the analyte tested by the test region 112A. Having a number of different test regions 112A-N and corresponding reference regions 114A-N may be included to expand the colorimetric testing platform to test different analytes of the same or different biological or non-biological liquids. In one embodiment, the test region 112A and the reference region 114A may constitute a single testing unit of the reagent test strip 103. Each testing unit may be adjacent to another testing unit or there may be a spacing between each testing unit.

Other parts of the reagent test strip illustrated in FIG. 1, comprise the handling region 106 and the reagent test strip substrate on which the test region and the reference color regions are incorporated. The handling region typically is a bare test strip substrate or similar rigid or semi-rigid material that provides an area for user to hold the test strip during storage, handling, and use. A substrate typically comprises a semi-rigid material that is capable of providing structural support to a test strip platform in which it may be incorporated. The substrate may comprise of a material like plastic (e.g., PET, PVC, PETG, polyimide, polycarbonate, polystyrene) ceramic, glass, paper or plastic-paper laminate. In some instances, the substrate may be made of metal. In some instances, the substrate may be pre-treated to allow printing to obtain accurate color representation on the substrate. The test strip precursor substrate may be in the form of a continuous tape or roll, a rectangular card or any other analogous form or a web. The web could be composed of paper, polymer-coated paper, plastic film or similar material. In one embodiment, the test strip precursor substrate may come pre-printed in the desired color pattern, details of which are described in description of the specific embodiments later in the discussion.

The colorimetric reaction test platform embedded in the reagent test strip may be useful for analyzing various types of analyte in a sample. The analyte may be detected by the image analysis, in particular colorimetric change or appearance. Such a test platform may be used to measure analyte with samples of biological fluids such as blood, saliva, sweat, urine, or samples of non-biological fluids such as pool & spa water, drinking or industrial water, waste water or treated water, or in fluids found in industrial environments such as heavy metals in the industrial systems.

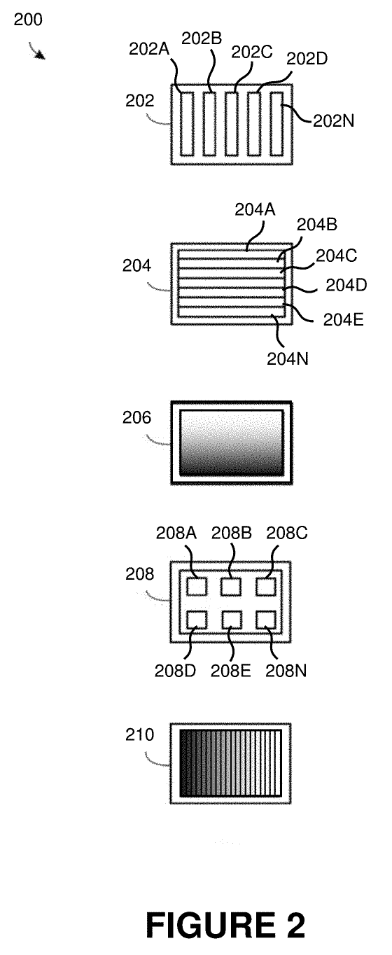

FIG. 2 illustrates various color patterns that may be used in the reference regions 104A-N and reference regions 110 in FIG. 1 of the reagent test strip, in accordance with at least one embodiment. Reference regions 200 may constitute multiple colors in various shapes or gradients in different directions. For example, reference region 202 comprises a variety of vertically oriented rectangles 202A-N, each having a distinct color, or collectively creating a color gradient (e.g. reference region 210). Alternately, reference region 204 may employ the same scheme, but may comprise horizontal rectangles 204A-N. Alternately, reference region 206 may comprise a gradual color gradient (i.e. not segmented). Reference region 208 may comprise a square or tile color pattern; other reference regions with similar patterns arranged in any order or direction or having segmented or non-segmented shapes or comprising irregular shapes are contemplated. The said shapes of color patterns in reference region 202 or reference region 204 or color gradient of reference region 206 may be disposed in any direction with respective to the reagent strip.

The reference regions 202-210 may comprise multiple colors that may be used during the reading of the reagent test strip, either with the readings by a naked eye, or more particularly for use in conjunction with a commercially available mobile application used to conduct an image analysis of the image of the reagent test strip taken after the colorimetric reaction has taken place in the test region. Depending on the type of analyte applied to a test region, a specific type of reference region may be suitable for image analysis of the test strip and ultimately, determination of the concentration of the analyte. A test strip may have one or more reference regions, each of which may be the same or different, depending on the type of analyte being tested with the reagent test strip.

In one embodiment, the horizontal rectangles 204A-N of reference region 204 and vertical rectangles 202A-N of reference region 202 or reference region 210 may be used collectively or individually by a pattern recognition module to determine a calibration curve or image color correction utilized to determine at least the qualitative value of an analyte applied to the one or more test regions of the reagent strip. The rectangles may be of a different color or may constitute a gradient. In one instance, the calibration curve for a test region to measure the analyte concentration can be determined by associating each of the color in reference region (e.g., rectangles 204A-N) to a color expected when the test region is exposed to a known standard concentration of the analyte. The calibration curve can then be constructed by color values as y-values (e.g., in Red, Green, and Blue or RGB color space or Hue, Saturation, Luminescence or HSL color space) and the standard concentration of each of the color pattern as x-values (i.e., concentration of the analyte). The x-y plot for each of the color parameter (i.e., RGB or HSL) as y-values and the concentration of the analyte (x-values) can be used to determine the qualitative value or quantitative value of the analyte. For instance, the qualitative value can be determined by comparing the color produced in the test region to a closest color match to the color patterns (e.g., rectangles 204A-N) by the calibration curve. Further, the quantitative value can be determined by the calibration curve having ability to interpolate between the values of the concentration (x-values) associated with each of the color patterns using the digital color space parameters such as R, G and B or the H, S, and L. Other color space such as L*a*b or similar can be used.

In one embodiment, the reference region may comprise a varying level of grayscale regions. Such grayscale regions can be used to adjust the image corresponding to eliminate the effect of the varying source of lighting conditions and facilitate a comparison with a predetermined calibration curve obtained at standard conditions. Such image processing to adjust the image based on the gray scale intensity (e.g., applying white balance to the image) is well-known to the person of ordinary skill in the art of image processing and image analysis. In one embodiment, the color pattern in reference region comprises multiple colors printed with the “true” color systems that are commonly used in the reference color card for photography. Examples of such reference color systems include Gretec-Macbeth color chart and X-rite CameraTrax™ 24 Color reference color card. As such, any “true” color can be printed using the color systems that are commonly known to the art of color printing using color match systems such as PANTONE™, ANPA, TRUEMATCH, FOCOLTONE, DIC color guide and similar systems that can be used to pick a color that is close match to the color required to adjust an image or apply color correction.

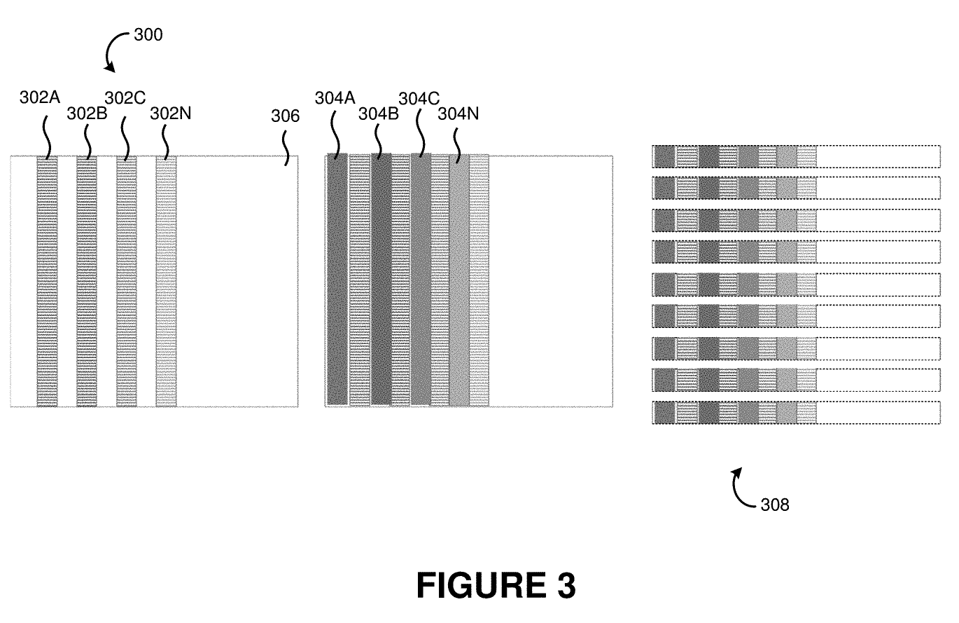

FIG. 3 illustrates a manufacturing process 300 for manufacturing reagent test strips 308 containing one or more reference regions 302A-N having a horizontally-striped pattern and one or more colorimetric test regions 304A-N on the test strip precursor substrate 306 to obtain reagent test strips 308 in a continuous process, in accordance with at least one embodiment. A continuous process (e.g., one in which various rolls of material are brought together to produce the precursor) such as in a continuous sheet coating process, or a discontinuous process (e.g., one in which the strip portions are first cut and then joined to each other) may be employed. Other modes of multiple-component strip fabrication may also be employed. The manufacturing process 300, in particular involves printing of the color pattern in spaced columns on the test strip precursor substrate 306 to produce the reference color regions 302A-N. Prior to the deposition of the test regions 304A-N, the reagent web material is typically solution coated with the required colorimetric reagents, dried, and cut to the desired column width to produce the required test platform of pre-treated reagent web material. The web material available for such reagent coating are porous web material such as strengthened cellulose fiber or cotton web commonly available from suppliers such as Whatmann, GE or other similar typically known to one skilled in the art of lateral flow assay or strip manufacturing. The adhesion of the reagent web material to the substrate is typically achieved by a double sided thin adhesive tape that sticks to the reagent web material on one side and the precursor substrate on the other side or other similar means known to one skilled in the art. Multiple different or similar rolls of reagent web materials of desired width of the test region can be deposited on substrate 306 adjacent to reference regions 302A-N in a continuous roll coating process. Followed by the deposition of the test regions 304A-N on the test strip precursor substrate 306 and cutting of the test strip precursor substrate 306 in an orthogonal direction to the printed columns, the manufacturing process 300 produces reagent test strips 308 with the color charts or patterns of the reference region 302A-N adjacent to the test region 304A-N in the test platform. Furthermore, each column may be different in the printed substrate thereby allowing multiple test and reference color regions to be embedded into a single test platform. The reference regions 302A-N may comprise any one or more of the reference regions 202-210 illustrated in FIG. 2 one or more vertical lines of the same or different color.

The reference color pattern may be printed adjacent to the colorimetric assay in the paper strip. The deposit and printing of the colorimetric test region and the color charts respectively may be achieved using the standard manufacturing platform commonly used during the manufacturing of the colorimetric analysis test strips and is commonly known to one of ordinary skill in the art. The resulting test platform with color chart can then be used to determine or interpret the analyte value from the colorimetric assay test platform to generate a mobile based system for colorimetric test analysis, display of the test results, and recording and displaying the history.

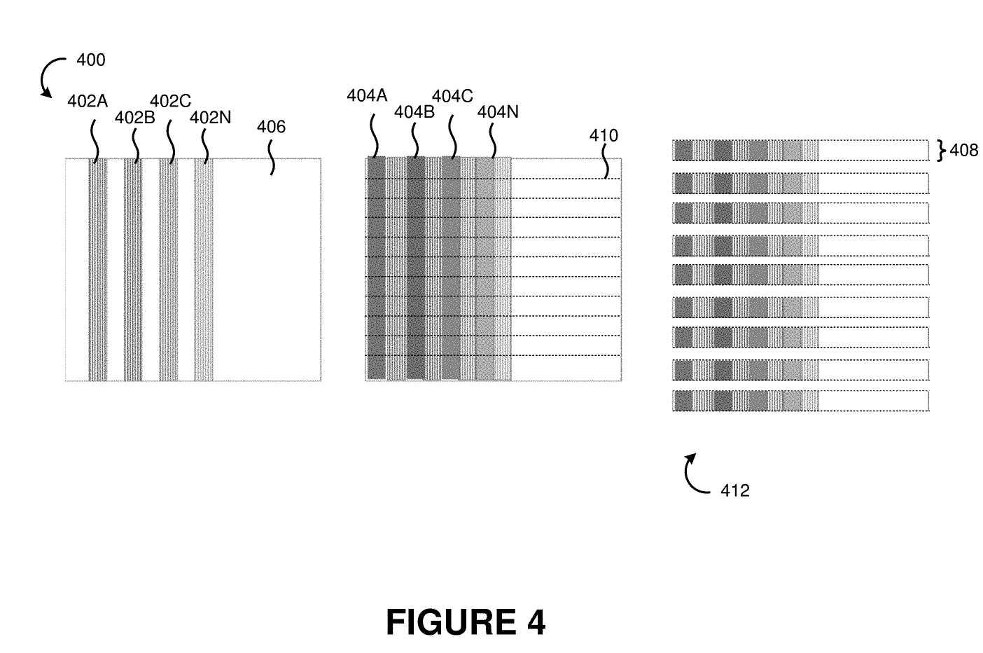

FIG. 4 illustrates a manufacturing process 400 for manufacturing reagent test strips 412 containing one or more reference regions 402A-N having a vertically-oriented pattern and one or more colorimetric test regions 404A-N on a test strip precursor substrate 406 to obtain reagent test strips 412, in accordance with at least one embodiment. The test strip precursor substrate 406 may be a paper, a plastic or similar substrate. The reference regions 402A-N having a vertically-oriented pattern are printed in a pattern or lines on the test strip precursor substrate 406. The printing can be achieved by the various color printing processes on the substrate known in the art. The reference color pattern lines may be printed at a regular interval with a specified width between each of the reference regions 402A-N. In a subsequent step, test regions 404A-N containing the reagent web material may be deposited adjacent to the reference regions 402A-N. The width between each of the reference region 402A-N is typically more than the width of the test regions 404A-N to accommodate the deposition of the such test strip containing reagent materials. After the test regions 404A-N containing reagent web materials as a test platform are applied, the process may include a drying step to dry the reagents or for the test strip reagents to adhere to the substrate. A process similar to one described to prepare and deposit test regions 304A-N in FIG. 3 may be used. Suitable adhesive may be used along with the web containing reagent to promote sticking of the reagent web to the test strip precursor substrate 406 adjacent to the reference regions 402A-N.

As illustrated in 412, the test strip precursor substrate 406 may then be cut to a pre-defined width 408 along a marking line 410, in accordance with at least one embodiment. The pre-defined width 408 of the marking line 410 is used for cutting of the test strip substrate 406 containing the reference color region 402 and the test regions 404 to obtain the plurality of reagent test strips 412.

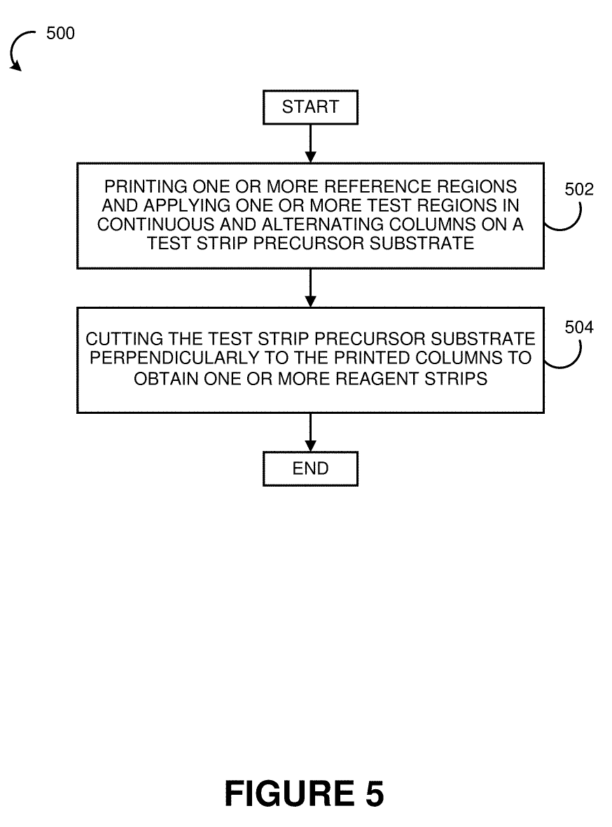

FIG. 5 illustrates a flowchart 500 of a method of manufacturing reagent test strips comprising one or more test regions and one or more reference regions, in accordance with at least one embodiment. The manufacturing of the reagent test strips involves the step 502 of printing one or more reference regions and applying one or more test regions in continuous and alternating columns on a test strip precursor substrate. The width of the one or more reference regions is determined by the width of the desired reagent test strips. The method also involves a step 504 of cutting the test strip precursor substrate perpendicularly to the printing columns to obtain one or more reagent strips.

The one or more reference regions may display a response to a range of the state or value of the analyte expected in the sample. The width of the colorimetric reagent test strip is typically within the range of ⅛ inch to ½ inch.

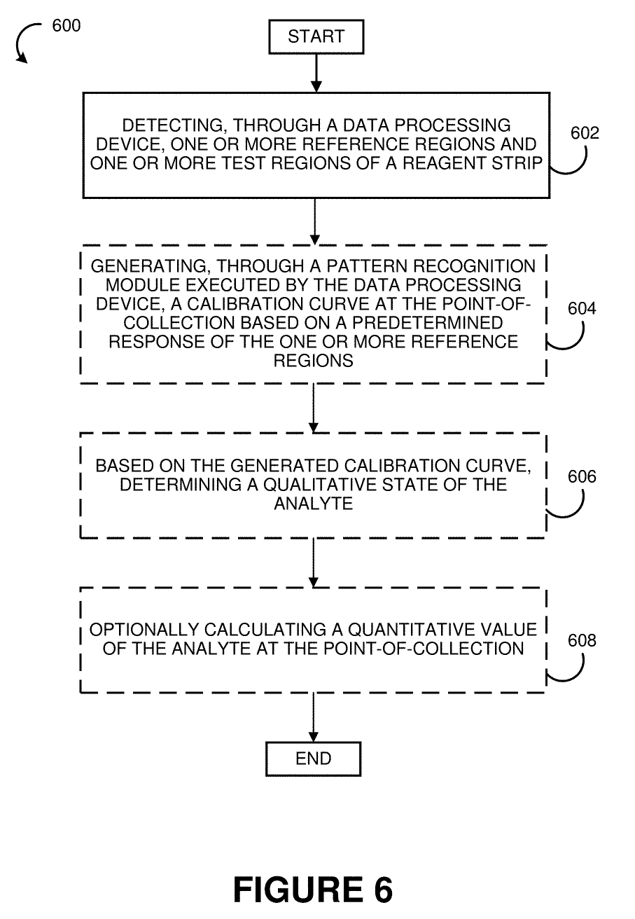

FIG. 6 further illustrates a flowchart 600 of a method to analyze reagent test strips for obtaining a qualitative state of an analyte, and optionally determining a quantitative value of an analyte in a sample using the reagent test strips through a mobile device, in accordance with at least one embodiment.

The method to analyze reagent test strips starts at step 602 of detecting, through a data processing device, one or more reference regions and one or more test regions of a reagent strip. Step 602 is then followed by Step 604 of generating, through a pattern recognition module executed by the data processing device, a calibration curve at the point-of-collection. The calibration curve may be based on a predetermined response of the one or more reference regions. Optionally, the calibration may comprise image or image section adjustment or correction based on the color or grey patterns in the reference region at point-of-collection. If the image adjustment is done, a pre-determined calibration curve at specified conditions when the image was corrected can be used to determine the qualitative or quantitative state of the analyte. Step 604 is followed by a step 606 of determining a qualitative state of the analyte based on the calibration curve. Step 606 is followed by a step 608 of optionally calculating a quantitative value of the analyte at the point-of-collection. The pattern recognition of the obtained image operates irrespective of the orientation of the reagent test strip in the obtained image. In one embodiment, the predetermined response of the one or more reference regions may comprise a colored pattern or any other way of indicating a range of a qualitative state and/or a quantitative value of the analyte in the corresponding one or more test regions.

The colorimetric reagent test strip may be sensitive to at least one of: a chemical colorimetric reaction; an enzymatic colorimetric reaction; and a nanoparticle colorimetric reaction. The analyte may comprise one or more of: pH; free chlorine; bromine; alkalinity; hardness; cholesterol; glucose; urine glucose; urine ketose; urine pH; and urine blood, in accordance with at least one embodiment.

In one embodiment, a method of obtaining a qualitative state or quantitative value of the analyte from a sample using the reagent test strips containing a reference color region and a test region containing reagent material may comprise: a) obtaining the color image of test region and the reference color region(s) after exposure to the said sample; b) obtaining the color values of the test region and the reference regions from the image, c) generating a calibration curve using the reference region, and d) determining the value or state of the analyte from the color produced in the test region. The reference region(s) may be adjacent to the said reagent material(s) in the reagent test strip and the said reference regions may correspond to the expected state of the analyte concentration in the sample for each of the test region in the reagent test strip. In another embodiment, the reference region(s) may display color patterns of a response to the various expected state of the analyte concentration in the sample. In another embodiment, the reference region(s) may display color patterns or grey patterns used to adjust the image at point-of-collection conditions. Based on the type of sample being applied to the reagent test, the response may for example prompt a pattern recognition module that the analyte will be in an approximate range of concentrations, or what kind of analyte is expected, or may aid in the generation of a calibration curve to be used when determining the qualitative state and optionally calculating the quantitative state of the analyte.

An embodiment of the invention is a method of using the reagent test strips containing a test region and a corresponding reference color region to be used with a mobile device to determine a qualitative state (e.g., detecting the presence of) and/or a quantitative value (e.g., determine the concentration of an analyte) in a sample. In this method, the first step is to apply a sample in which the analyte determination is needed to the reagent test strip. Following the exposure of the sample to the reagent test strip, the sample is allowed to react with the test regions embedded in the reagent test strips to produce a detectable color change on the test strip due to the colorimetric reaction described in previous sections. Following the completion of the reaction or when the color of the test region is optimally developed, a camera from a mobile device is used to take the picture of the entire reagent test strips. The image is then analyzed by the corresponding application or app in the mobile device to obtain the color values in the test region and color values from the reference color region corresponding to the associated color pattern in the reference region. For each of the test regions of the reagent test strip, a calibration curve corresponding to a range of the expected value of the analyte is generated from the corresponding reference color pattern consisting of multiple colors using the image analysis by the embedded application. Finally, algorithms may be used to determine the corresponding state of the analyte by comparing the color generated in the test region to the corresponding color associated in the reference color region to determine the analyte in the sample.

In one embodiment of the invention, one or more algorithms may be used to determine the analyte from the color produced in the test region and compare the color to the reference color region of the reagent test strip. In one embodiment, an algorithm may be implemented by an application executable by a smartphone or other mobile device or remotely in a cloud server and may first capture the image of the reagent test strip and initially define colors (i.e. of the reference color regions and the test regions) using RGB (red green blue) channel values from the sensors. The RGB values may be converted to an alternate color space that can be used to compare the color from the test region to the reference color region. In a simplistic case, the algorithm comparing the RGB values of the test region to the various colors in the reference region may be used to determine the analyte value in the test region by using lowest root mean square error produced by comparing each of the R, G and B channel. This analysis provides a less processor intensive route to compare the color of the test region and the reference region. Further the calibration curve can be obtained by a polynomial fitting of the R, G and B channel intensity in the reference region to its corresponding state of the analyte concentration as known from the manufacturing of the reagent strip. Where additional accuracy is required to determine the quantitative state of the analyte concentration, an alternative approach to convert the RGB values to an alternate color space such as HSL (Hue Saturation Luminance) or xyY color space or L*a*b color space can be done.

One embodiment of the invention involves automatic pattern recognition of the image of the reagent test strip containing test regions and the reference regions. For such a pattern recognition feature, the algorithm analyzes the patterns present in the image containing a reagent test strip and identifies the regions corresponding to the test region and the reference region according to a predetermined set of the instructions. Such pattern recognition is known to the person familiar with the state of the art of image processing and recognition, examples of which include a barcode scanner and other open source software development kit (SDK) such as opencv framework for image analysis. The pattern recognized in an image can further be separated into the test region and the reference region. The reference region can be further broken down to individual color in the reference color pattern to get color values of individual areas of the reference region. The color values of the reference regions corresponding to each of the test region are used to generate a calibration curve.

An embodiment of the invention recognizes that the application can provide an ability to select the test region and its corresponding reference color region for the image analysis to determine the state of the analyte in the sample from the color developed in the test region. The color measurement steps and analyte concentration calibration derivation steps are then performed automatically by a mobile device with the app as designed to work with the test strip to produce a value of analyte concentration in a sample applied to the test strip using the reference region(s) produced by the manufacturing method.

The methods described herein may be useful for analyzing various types of reagent test strips so long as the test strip results in a colorimetric change that can be detected by the methods described herein. Test strips according to the present invention may be provided in packaged combination with means for obtaining a physiological sample and/or instructions or a corresponding software application or app. Where the physiological sample to be tested by a strip is blood, the subject kits may include a tool such as lance for sticking a finger, a lance actuation means, or the like.

Similarly, when the physiological sample to be tested by a strip is urine, the subject kit may include a urine collection cup. Finally, a kit may include instructions for using test strips according to the invention in the determination of an analyte state. These instructions may be present on one or more of containers(s), packaging, a label insert or the like associated with the subject test strips.

Embodiments of the invention include a program or application that includes instructions executable on a process system such as a mobile phone, a smartphone, a tablet, a portable computer or computer system capable of carrying out the steps of the method.

In the present method an area of particular importance lies in suitable use of the substrate such that it can produce the desired color reference chart close to the associated reagent test strip section used in the detection of the analyte when exposed to the measurement fluids. Such measurement fluids include urine, tears, saliva, whole blood and other products such as pool water, industrial and environmental samples.

A procedure demonstrating the efficacy of the reagent strip and the mobile application in determining a qualitative state and/or a quantitative value of an analyte was conducted, the results of which are provided in Tables 2-4B. The procedure described as follows may be one example of a procedure that may be conducted to test the efficacy of the reagent strip and the mobile application. Other procedures incorporating any modification(s) (calculating concentrations of different analytes (e.g. leukocytes, ketones), using different types of reference regions as described in FIG. 2, preparing the reagent strips in different ways as described in FIGS. 3-4, etc) may be performed to demonstrate the efficacy of the one or more embodiments described herein.

The procedure involved preparing one or more reagent strips as described in FIGS. 3-4. The reagent strips were prepared with reagents for colorimetric testing of blood, glucose, and protein in urine samples. A reference region pattern was prepared in ADOBE® Illustrator® comprising parallel lines of approximately 1 mm thickness, wherein the lines were filled with colors corresponding to the expected response provided in the visual interpretation guide (Table 1). The patterns containing horizontal parallel lines were then printed with precise color printing using the PANTONE® color scheme to replicate the color schemes provided in Table 1. The reference color patterns were printed at a total width of 6 mm (each rectangle of width of 1 mm with 0.2 mm white space between the lines) using a color printer. The printed patterns were then adhered to the space between the two filter reagent pads in the prepared substrate. The printed color pattern was positioned adjacent to each of the corresponding reagent pad in this case, but an alternate procedure where the reagent pad is deposited close to the printed substrate is possible and desirable. The substrate with the reagent pad and the color pattern were then cut perpendicular to the deposited pads to obtain individual strips containing the reference region and the color region. A color pattern for each of the individual test regions was generated from the color response profile for visual interpretation of the analyte concentration results for the reagent strips. The reference region color patterns were prepared in a CMYK color format generated from a matching PANTONE® coated visual color book in an Illustrator® file. Table 1 provides typical color responses corresponding to varying concentrations of each analyte (blood, glucose, protein) in the reagent strip.

The procedure involved determining the concentration of an analyte at a point-of-collection using three methods: generating a calibration curve through the mobile app based on the reference regions of the reagent strip, as described in the present invention (“inventive example”); a manual, naked-eye determination using a manufacturer reference color chart (“visual observation”); and a comparative example using a standard, predetermined calibration curve that is used for all images without any adjustment (“comparative example”). The data provided in Tables 2-4B provide data produced through these three methods.

The mobile app in this procedure was an iOS application, but may have Android or Windows Phone analogues. The mobile app was developed using Xcode and incorporates an algorithm for image analysis and pattern recognition. The app was developed such that it allowed a user to capture an image of the reagent strip, analyze the reagent strip to identify the test regions and the reference regions, carry out calculations to quantify the color response with respect to reference, and display the results. The image analysis algorithm recognized each of the individual test regions and corresponding reference regions. The app evaluated and recorded the median R, G, and B value of the test regions, and the median R, G, and B values of each color of the color patterns in the reference regions. Typically, each reference region had a pattern of 5 to 6 colors (median RGB as y-values) corresponding to specified concentrations of analytes (x-values) in each test region. For each reference region, the app generated a polynomial fit of order 3 based on the calibration (x, y-values) corresponding to each of the R, G, and B channel. This polynomial fit was then used to calculate the analyte concentration from the median R, G, and B values obtained from the test region based on the least square fit of R, G and B values from the calibration curve generated by polynomial fit.

Table 2A shows data for multiple measurements of blood cells (erythrocytes) in a negative control urine sample. The data shown in Table 2A demonstrates that the inventive example accurately determines the negative control, similar to the visual observation, while accuracy is lost when a predetermined calibration curve is used (instead of the reference region calibration curve generated in the inventive example). Table 2B shows data for multiple measurements of blood cells (erythrocytes) in a positive control urine sample. The data shown in Table 2B demonstrates that the standard deviation for the inventive example is lower compared to that of the visual observation and the comparative example. The accuracy of the inventive example is the closest to the positive control value (approximately 40 cells/μl). Accuracy can further be improved by using other color spaces such as L*a*b described in the invention.

Table 3 shows data for multiple measurements of glucose in a positive control urine sample. The data shown in Table 3 demonstrates that the standard deviation for the inventive example is lower compared to visual observation or the comparative example. Table 4A shows data for a multiple measurements of proteins in a negative control urine sample. The data shown in Table 4A demonstrates that the inventive example accurately determines the negative control, similar to the visual observation, while accuracy is lost when a predetermined calibration curve is used in the comparative example. Table 4B shows data for multiple measurements of proteins in a positive control urine sample. The data shown in Table 4B demonstrates that the standard deviation for the inventive example is lower compared to visual observation or the comparative example, while the average value measured using comparative example was outside the range of the control sample used in the study. The inventive example accurately determined the measurement close to the value of protein in the control sample.

No language in the specification should be construed as indicating any non-claimed element as essential to the practice of the invention. It will be apparent to those skilled in the art that various modification and variations can be made to the present invention without departing from the spirit and scope of the invention. There is no intention to limit the invention to the specific form or forms enclosed, but on the contrary, the intention is to cover all modification, alternative construction, and equivalents falling within the spirit and scope of the invention, as defined in the appended claims. Thus, it is intended that the present invention cover the modification and variation of this invention provided they come within the scope of the appended claims and their equivalents.

TABLE 1
Visual interpretation guide (Typical color responses)

| Blood | | Protein, | | Glucose, | |
|---|---|---|---|---|---|
| Quantitative | | Quantitative | Visual Color | Quantitative | |
| values | Visual Color | values | response | values | Visual Color |
| (cells/μl) | (CMYK) | (g/l) | (CMYK) | (mmol/l) | (CMYK) |
| 0 | Light orange | 0 | Yellow | 0 | Turquoise |
| 10 | Orange | 0.15 (trace) | Yellowish | 5 | Light green |
| | | | green | | |
| 25 | Green- | 0.3 | Sage | 15 | Green |
| | orange | | | | |
| 80 | Green | 1.0 | Light green | 30 | Light brown |
| 200 | Dark Green | 3 | Green | 60 | Medium brown |
| | | 20.0 | Dark green | 110 | Dark brown |

TABLE 2A
Blood cell measurement in urine sample - Negative Control

| | Inventive | Visual Observation | |
|---|---|---|---|
| | Example (app) | by User | Comparative Example |
| | 0.0 | 0.0 | 1.2 |
| | 0.0 | 0.0 | 0.0 |
| | 0.0 | 0.0 | 0.0 |
| | 0.0 | 0.0 | 0.0 |
| | 0.0 | 0.0 | 3.2 |
| | 0.0 | 0.0 | 1.1 |
| | 0.0 | 0.0 | 0.0 |
| | 0.0 | 0.0 | 1.7 |
| Avg | 0.0 | 0.0 | 0.9 |
| Stdev. | 0.0 | 0.0 | 1.2 |

TABLE 2B
Blood cell measurement in urine sample - Positive Control

| | Inventive | Visual Observation | |
|---|---|---|---|
| | Example (app) | by User | Comparative Example |
| | 33.6 | 15 | 3.1 |
| | 60.8 | 25 | 8.4 |
| | 13.6 | 25 | 20.8 |
| | 36.8 | 25 | 8.9 |
| | 20.8 | 25 | 27.1 |
| | 53.6 | 28 | 13.9 |
| | 53.6 | 28 | 13.9 |
| | 54.4 | 30 | 38.7 |
| | 44 | 30 | 22.5 |
| | 40 | 30 | 35.0 |
| | 58.4 | 35 | 36.6 |
| | 32 | 40 | 29.6 |
| | 55.2 | 50 | 62.7 |
| | 52 | 50 | 57.9 |
| | 34.4 | 60 | 46.3 |
| | 61.6 | 60 | 31.2 |
| | 42.4 | 60 | 47.6 |
| | 27.2 | 60 | 19.5 |
| | 59.2 | 80 | 36.5 |
| | 1.6 | 80 | 9.5 |
| | 29.6 | 80 | 60.4 |
| | 12 | 100 | 3.9 |
| | 68.8 | 100 | 60.9 |
| Avg | 41.1 | 48.5 | 30.2 |
| Stdev. | 18.0 | 25.5 | 19.1 |

TABLE 3
Glucose measurement in urine sample - Positive Control

| | Inventive | Visual Observation | |
|---|---|---|---|
| | Example (app) | by User | Comparative Example |
| | 16.8 | 15 | 3.2 |
| | 18 | 20 | 11.7 |
| | 18 | 25 | 12.9 |
| | 30 | 25 | 24.3 |
| | 30 | 25 | 10.1 |
| | 29.7 | 30 | 28.6 |
| | 15.6 | 30 | 23.0 |
| | 30 | 30 | 13.4 |
| | 17.4 | 30 | 19.9 |
| | 19.5 | 30 | 46.8 |
| | 26.7 | 30 | 11.2 |
| | 26.7 | 30 | 11.2 |
| | 30 | 30 | 12.1 |
| | 12.9 | 30 | 0 |
| | 30 | 30 | 0 |
| | 27 | 40 | 25.2 |
| | 30 | 45 | 18.2 |
| | 28.2 | 50 | 22.4 |
| | 30 | 60 | 33.4 |
| | 25.8 | 60 | 33.4 |
| Avg | 24.6 | 33.3 | 20.1 |
| Stdev. | 6.1 | 12.0 | 10.8 |

TABLE 4A
Protein measurement - Negative Control

| Inventive Example | Visual Observation by | |
|---|---|---|
| (app) | User | Comparative Example |
| 0.0 | 0.0 | 5.6 |
| 0.0 | 0.0 | 5.6 |
| 0.0 | 0.0 | 5.7 |
| 0.0 | 0.0 | 6.8 |
| 0.0 | 0.0 | 6.6 |
| 0.0 | 0.0 | 5.7 |
| 0.0 | 0.0 | 6.5 |
| 0.0 | 0.0 | 6.5 |

TABLE 4B
Protein measurement - Positive Control

| | | Visual | |
|---|---|---|---|
| | Inventive Example | Observation by | |
| | (app) | User | Comparative Example |
| | 0.95 | 1 | 5.4 |
| | 0 | 1 | 6.3 |
| | 1 | 1 | 4.7 |
| | 1 | 1 | 5.0 |
| | 0.96 | 1 | 5.1 |
| | 0.96 | 1 | 5.1 |
| | 0.99 | 1 | 4.7 |
| | 0.91 | 1.2 | 4.9 |
| | 1 | 1.2 | 4.0 |
| | 0.9 | 1.2 | 4.5 |
| | 0.39 | 1.2 | 4.6 |
| | 1 | 1.5 | 4.9 |
| | 0.7 | 1.5 | 4.2 |
| | 0 | 1.5 | 4.0 |
| | 0.37 | 1.5 | 3.5 |
| | 1 | 2 | 3.9 |
| | 0.52 | 2 | 3.8 |
| | 0.93 | 2 | 4.4 |
| | 0.79 | 2.5 | 4.9 |
| | 0.18 | 2.5 | 4.3 |
| | 0.86 | 2.7 | 3.5 |
| | 0.99 | 3 | 4.4 |
| | 1 | 5 | 3.5 |
| Avg | 0.76 | 1.72 | 4.50 |
| Stdev. | 0.34 | 0.95 | 0.68 |

What is claimed is:

1. A reagent test strip suitable for determining a qualitative state or quantitative value of an applied analyte, the reagent test strip comprising:
a strip precursor substrate; and
a continuous array of analysis regions disposed on the strip precursor substrate, each of the analysis regions configured as either a test region provided to receive the applied analyte or as a reference region provided to display a specified pattern;
the reagent test strip having each reference region disposed adjacent to one of the test regions so as to enable acquisition of an image consisting of both a selected test region having the applied analyte and a selected reference region, whereby the qualitative state or quantitative value of the applied analyte can be determined at a point-of-collection, wherein the determination of the qualitative state or quantitative value of the applied analyte on the selected test region is based on a calibration performed based on the specified pattern on the corresponding selected reference region.

2. The reagent test strip of claim 1, wherein the specified pattern of the selected reference region represents a range of predetermined responses of the corresponding selected test region to a range of concentrations of the applied analyte.

3. The reagent test strip of claim 1, wherein the continuous array of analysis regions comprises a linear array on the reagent test strip with the analysis regions being arranged such that each of the test regions is disposed adjacent to a corresponding one reference region of the reference regions, and such that each of the reference regions is disposed adjacent to a corresponding test region of the test regions.

4. The reagent test strip of claim 1, wherein each of the reference regions comprises one of a specified color pattern and a specified gray pattern.

5. The reagent test strip of claim 1, wherein the sizes and shapes of the test regions are substantially the same as the sizes and shapes of the reference regions.

6. The reagent test strip of claim 1, wherein a width of one of the reference regions is equal to or less than a width of one of the test regions.

7. The reagent test strip of claim 1, wherein at least one of the test regions functions to measure at least one of: pH, free chlorine, bromine, alkalinity, hardness in water samples; cholesterol and glucose in blood samples; and glucose, ketones, pH, and blood in urine samples.

8. The reagent test strip of claim 1, wherein at least one of the test regions produces a reaction to at least one of a chemical colorimetric reaction, an enzymatic colorimetric reaction, and a nanoparticle colorimetric reaction, the reaction including a changing in the appearance or a color of the one of the test regions upon application of the analyte.

9. A method of manufacturing reagent test strips for determining qualitative states or quantitative values of applied analytes, the method comprising the steps of:
printing a plurality of reference region columns and applying a plurality of test region columns in a continuous and alternating series on a test strip precursor substrate, each reference region column disposed adjacent to at least one of the test region columns, each test region column disposed adjacent at least one of the reference region columns; and
cutting the test strip precursor substrate perpendicularly to the printed columns to produce a plurality of the reagent test strips, each reagent test strip having disposed thereon a linear array of reference regions and test regions.

10. The method of claim 9, wherein each of the reference regions displays a predetermined response to a range of possible concentrations of an analyte applied to a corresponding test region of one of the reagent strips.

11. The method of claim 10, wherein the predetermined response comprises a color pattern.

12. The method of claim 9, wherein the determination of the qualitative state or quantitative value of an applied analyte is based on a calibration performed based on the predetermined response.

13. The method of claim 9, further comprising a step of using a pattern recognition module of a data processing device, at the point-of-collection, on a selected reference region to generate a calibration curve so as to derive at least one of the qualitative state and the quantitative value of the analyte applied to the corresponding test region.

14. The method of claim 13, wherein the step of using the pattern recognition module is performed using one of the reagent strips in any orientation relative to the data processing device.

15. The method of claim 9, wherein the one or more test regions comprise a sensitivity to at least one of a chemical colorimetric reaction, an enzymatic colorimetric reaction, and a nanoparticle colorimetric reaction, one or more of the reactions acting to change an appearance or a color of the one or more test regions.

16. The method of claim 9, wherein the test regions function to measure at least one of: pH, free chlorine, bromine, alkalinity, hardness in water samples; cholesterol and glucose in blood samples; and glucose, ketones, pH, and blood in urine samples.

17. A method of measuring a concentration of an applied analyte at a point-of-collection using a reagent test strip, the method comprising the steps of:
detecting, through a data processing device, a continuous array of analysis regions disposed on the reagent test strip, each of the analysis regions configured as either a test region provided to receive the applied analyte or as a reference region provided to display a specified pattern, wherein each reference region is disposed adjacent to at least one test region so as to enable acquisition of an image consisting of both a selected test region having the applied analyte and a selected reference region;
determining a qualitative state of the applied analyte at the point-of-collection; and
optionally calculating a quantitative value of the analyte at the point-of-collection based on a calibration performed at the point-of-collection based on the specified pattern of the selected reference region.

18. The method of claim 17, wherein the specified pattern of the selected reference region represents a range of predetermined responses of the corresponding selected test region to a range of possible concentrations of the applied analyte.

19. The method of claim 17, wherein the predetermined response comprises a color pattern.

20. The method of claim 17, further comprising the step of generating, through a pattern recognition module executed by the data processing device, a calibration curve at the point-of-collection based on the predetermined response.
